(19) United States
(12) Patent Application Publication
(10) Pub. No.: US 2007/0179247 A1
(43) Pub. Date: Aug. 2, 2007

(54) Pneumatic tire

(75) Inventors: Paul Harry Sandstrom, Cuyahoga Falls, OH (US); Junling Zhao, Hudson, OH (US); Aaron Scott Puhala, Kent, OH (US); Bina Patel Botts, Cuyahoga Falls, OH (US); James William Prentis, Akron, OH (US); Jennifer Lyn Ryba, Wadsworth, OH (US)

Correspondence Address: THE GOODYEAR TIRE & RUBBER COMPANY;INTELLECTUAL PROPERTY DEPARTMENT 823, 1144 EAST MARKET STREET, AKRON, OH, 44316-0001, US

(73) Assignee: The Goodyear Tire & Rubber Company

(21) Appl. No.: 11/708,413

(22) Filed: Feb. 20, 2007

Related U.S. Application Data
(63) Continuation-in-part of application No. 10/921,528, filed on Aug. 19, 2004, now abandoned.

(51) Int. Cl. C08F 8/00

(52) U.S. Cl. 525/191

(57) ABSTRACT

A pneumatic tire having a component comprising: at least one rubber selected from polybutadiene rubber, styrene-butadiene rubber, synthetic polyisoprene rubber, and natural rubber; and from 1 to 30 parts by weight, per 100 parts by weight of rubber, of a terpolymer of: ethylene, an α-olefin, and a non-conjugated diene; the terpolymer having an ethylene content of greater than 80 percent by weight and a Mooney viscosity (ML 1+4 at 125° C.) of from 5 to 25 as measured by ASTM D-1646.

### CROSS REFERENCE TO RELATED APPLICATIONS This application is a continuation-in-part of Ser. No. 10/921,528 filed Aug. 19, 2004.

### BACKGROUND OF THE INVENTION

U.S. Pat. No. 5,216,066 discloses a tire tread rubber compound containing a sulfonamide modified EPDM terpolymer which imparts improved abrasion resistance, improved ozone resistance, improved hysteresis, and the like.

U.S. Pat. No. 5,341,863 discloses a pneumatic tire having a sulfur cured tread comprised of at least one diene rubber and a low density polyethylene having a crystalline melting point of about 104° C. to about 115° C.

U.S. Pat. No. 5,964,969 discloses a pneumatic tire having a rubber sidewall with a portion composed of white rubber devoid of carbon black and composed of an elastomer composition of EPDM, chlorobutyl rubber, diene-based elastomers and liquid EPDM.

U.S. Pat. No. 6,255,372 discloses a tire having improved tear strength including at least one component comprising an elastomer, from 5 to 50 phr of polypropylene, and from 0.05 to 2 phr of an anhydride compatibilizer.

U.S. Pat. No. 6,274,676 discloses a tire having improved tear strength including at least one component comprising an elastomer, and up to 35 phr of polyolefin copolymer.

U.S. Pat. No. 6,602,954 discloses a tire having improved tear strength including at least one component comprising an elastomer and up to 35 phr of a functionalized polyolefin.

WO00/69930 discloses high crystallinity ethylene/α-olefin/polyene interpolymers.

### SUMMARY OF THE INVENTION

The present invention relates to a pneumatic tire having a component comprising: at least one rubber selected from polybutadiene rubber, styrene-butadiene rubber, synthetic polyisoprene rubber, and natural rubber; and from 1 to 30 parts by weight, per 100 parts by weight of rubber, of a terpolymer of: ethylene, an α-olefin, and a non-conjugated diene; the terpolymer having an ethylene content of greater than 80 percent by weight and a Mooney viscosity (ML 1+4 at 125° C.) of from 5 to 25 as measured by ASTM D-1646.

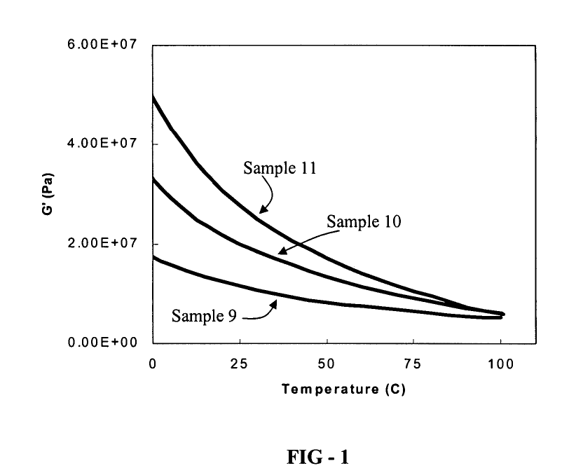

### BRIEF DESCRIPTION OF THE DRAWINGS FIG. 1 shows the effect of the terpolymer on compound stiffness at various temperatures.

### DETAILED DESCRIPTION OF THE INVENTION

There is disclosed a pneumatic tire having a component comprising: at least one rubber selected from polybutadiene rubber, styrene-butadiene rubber, synthetic polyisoprene rubber, and natural rubber; and from 1 to 30 parts by weight, per 100 parts by weight of rubber, of a terpolymer of: ethylene, an α-olefin, and a non-conjugated diene; the terpolymer having an ethylene content of greater than 80 percent by weight and a Mooney viscosity (ML 1+4 at 125° C.) of from 5 to 25 as measured by ASTM D-1646.

The terpolymer of: ethylene, an α-olefin, and a non-conjugated diene includes terpolymers composed of ethylene and propylene units and an unsaturated component (EPDM), ethylene and butene units and an unsaturated component, ethylene and pentene units and an unsaturated component, ethylene and octene units and an unsaturated, non-conjugated diene component, as well as mixtures thereof. Thus suitable α-olefins include propylene, butene, pentene, and octene, and mixtures thereof. As the unsaturated component of the terpolymer, any appropriate non-conjugated diene may be used, including, for example, 1,4-hexadiene, dicyclopentadiene or ethylidenenorbornene (ENB), or mixtures thereof. The terpolymer of: ethylene, an α-olefin, and a non-conjugated diene preferred in the present invention contains greater than 80 percent by weight of ethylene, from about 1 percent by weight to about 10 percent by weight of the α-olefin unit and 1 to 10 percent by weight of the non-conjugated diene component. In a more preferred embodiment, the terpolymer of: ethylene, an α-olefin, and a non-conjugated diene contains greater than 85 percent by weight of ethylene. The terpolymer of: ethylene, an α-olefin, and a non-conjugated diene is also characterized by a Mooney viscosity (ML 1+4 at 125° C.) of from 5 to 25 as measured by ASTM D-1646. Alternatively, the Mooney viscosity (ML 1+4 at 125° C.) of from 10 to 20 as measured by ASTM D-1646. The terpolymer of ethylene, an α-olefin, and a non-conjugated diene may be further characterized as being highly crystalline, with crystalline content greater than 25 percent by weight as measured by differential scanning calorimetry (DSC) at a rate of 10° C./minute. The most preferred terpolymner of ethylene, an α-olefin, and a non-conjugated diene is a terpolymer of ethylene, propylene, and ethylidenenorbomene.

The terpolymer of: ethylene, an α-olefin, and a non-conjugated diene can be produced using conventional ethylene/α-olefin polymerization technology as disclosed for example in U.S. Pat. No. 6,455,638. Preferably, the terpolymer components of this invention are made using a mono- or bis-cyclopentadienyl, indenyl, or fluorenyl transition metal (preferably Group 4) catalysts or constrained geometry catalysts (CGC) in combination with an activator, in a solution, slurry, or gas phase polymerization process. The catalyst is preferably mono-cyclopentadienyl, mono-indenyl or mono-fluorenyl CGCs. The solution process is preferred. U.S. Pat. No. 5,064,802; WO93/19104 (U.S. Ser. No. 8,003, filed Jan. 21, 1993), and WO95/00526 disclose constrained geometry metal complexes and methods for their preparation. Variously substituted indenyl containing metal complexes are taught in WO95/14024 and WO98/49212. The relevant teachings of all of the foregoing patents or their corresponding U.S. patents or allowed applications are hereby incorporated by reference for purposes of U.S. patent practice.

In general, terpolymer polymerization may be accomplished at conditions well known in the art for Ziegler-Natta or Kaminsky-Sinn type polymerization reactions, that is, temperatures from 0 to 250° C., preferably 30 to 200° C., and pressures from atmospheric to 10,000 atmospheres (1013 megapascals (MPa)). Suspension, solution, slurry, gas phase, solid state powder polymerization or other process conditions may be employed if desired. A support, especially silica, alumina, or a polymer (especially poly(tetrafluoroethylene) or a polyolefin) may be employed, and desirably is employed when the catalyst is used in a gas phase polymerization process. The support is preferably employed in an amount sufficient to provide a weight ratio of catalyst (based on metal):support within a range of from 1:100,000 to 1:10, more preferably from 1:50,000 to 1:20, and most preferably from 1:10,000 to 1:30. In most polymerization reactions, the molar ratio of catalyst:polymnerizable compounds employed is from 10⁻¹²:1 to 10⁻¹:1, more preferably from 10⁻⁹:1 to 10⁻⁵:1.

Inert liquids serve as suitable solvents for polymerization of the terpolymer. Examples include straight and branched-chain hydrocarbons such as isobutane, butane, pentane, hexane, heptane, octane, and mixtures thereof; cyclic and alicyclic hydrocarbons such as cyclohexane, cycloheptane, methylcyclohexane, methylcycloheptane, and mixtures thereof; perfluorinated hydrocarbons such as perfluorinated C₄-C₁₀ alkanes; and aromatic and alkyl-substituted aromatic compounds such as benzene, toluene, xylene, and ethylbenzene. Suitable solvents also include liquid olefins that may act as monomers or comonomers including butadiene, cyclopentene, 1-hexene, 1 -hexane, 4-vinylcyclohexene, vinylcyclohexane, 3-methyl-1-pentene, 4-methyl-1-pentene, 1,4-hexadiene, 1-octene, 1-decene, styrene, divinylbenzene, allylbenzene, and vinyltoluene (including all isomers alone or in admixture). Mixtures of the foregoing are also suitable. If desired, normally gaseous olefins can be converted to liquids by application of pressure and used herein.

Suitable terpolymer of ethylene, an α-olefin, and a non-conjugated diene are available commercially. For example, suitable terpolymer is available from Dupont-Dow Elastomers as Nordel® IP NDR 4820 and Nordel® IP NDR 4920.

In one embodiment, the rubber composition comprises from 1 to 30 parts by weight, per 100 parts by weight of rubber (phr), of the terpolymer of ethylene, an α-olefin, and a non-conjugated diene. In another embodiment, the rubber composition comprises from 5 to 15 phr of the terpolymer.

In addition to the terpolymer of ethylene, an α-olefin, and a non-conjugated diene, the rubber component contains a rubber containing olefinic unsaturation. The phrase “rubber or elastomer containing olefinic unsaturation” is intended to include both natural rubber and its various raw and reclaim forms as well as various synthetic rubbers. In the description of this invention, the terms “rubber” and “elastomer” may be used interchangeably, unless otherwise prescribed. The terms “rubber composition”, “compounded rubber” and “rubber compound” are used interchangeably to refer to rubber which has been blended or mixed with various ingredients and materials and such terms are well known to those having skill in the rubber mixing or rubber compounding art. Representative synthetic polymers are the homopolymerization products of butadiene and its homologues and derivatives, for example, methylbutadiene, dimethylbutadiene and pentadiene as well as copolymers such as those formed from butadiene or its homologues or derivatives with other unsaturated monomers. Among the latter are acetylenes, for example, vinyl acetylene; olefins, for example, isobutylene, which copolymerizes with isoprene to form butyl rubber; vinyl compounds, for example, acrylic acid, acrylonitrile (which polymerize with butadiene to form NBR), methacrylic acid and styrene, the latter compound polymerizing with butadiene to form SBR, as well as vinyl esters and various unsaturated aldehydes, ketones and ethers, e.g., acrolein, methyl isopropenyl ketone and vinylethyl ether. Specific examples of synthetic rubbers include neoprene (polychloroprene), polybutadiene (including cis-1,4-polybutadiene), polyisoprene (including cis-1,4-polyisoprene), butyl rubber, halobutyl rubber such as chlorobutyl rubber or bromobutyl rubber, styrene/isoprene/butadiene rubber, copolymers of 1,3-butadiene or isoprene with monomers such as styrene, acrylonitrile and methyl methacrylate. Additional examples of rubbers which may be used include a carboxylated rubber, silicon-coupled and tin-coupled star-branched polymers. The preferred rubber or elastomers are polybutadiene, SBR, and synthetic and natural polyisoprene.

In one aspect, the rubber to be combined with the ethylene/α-olefin elastomer may be a blend of at least two diene based rubbers. For example, a blend of two or more rubbers is preferred such as cis 1,4-polyisoprene rubber (natural or synthetic, although natural is preferred), 3,4-polyisoprene rubber, styrene/isoprene/butadiene rubber, emulsion and solution polymerization derived styrene butadiene rubbers, cis 1,4-polybutadiene rubbers and emulsion polymerization prepared butadiene/acrylonitrile copolymers.

In one aspect of this invention, an emulsion polymerization derived styrene butadiene (E-SBR) might be used having a relatively conventional styrene content of about 20 to about 28 percent bound styrene or, for some applications, an E-SBR having a medium to relatively high bound styrene content, namely, a bound styrene content of about 30 to about 45 percent.

When used in the tire tread, the relatively high styrene content of about 30 to about 45 for the E-SBR can be considered beneficial for a purpose of enhancing traction, or skid resistance. The presence of the E-SBR itself is considered beneficial for a purpose of enhancing processability of the uncured elastomer composition mixture, especially in comparison to a utilization of a solution polymerization prepared SBR (S-SBR).

By emulsion polymerization prepared E-SBR, it is meant that styrene and 1,3-butadiene are copolymerized as an aqueous emulsion. Such are well known to those skilled in such art. The bound styrene content can vary, for example, from about 5 to about 50 percent. In one aspect, the E-SBR may also contain acrylonitrile to form a terpolymer rubber, as E-SBAR, in amounts, for example, of about 2 to about 30 weight percent bound acrylonitrile in the terpolymer.

Emulsion polymerization prepared styrene/butadiene/acrylonitrile copolymer rubbers containing about 2 to about 40 weight percent bound acrylonitrile in the copolymer are also contemplated as diene based rubbers for use in this invention.

The solution polymerization prepared SBR (S-SBR) typically has a bound styrene content in a range of about 5 to about 50, preferably about 9 to about 36, percent. The S-SBR can be conveniently prepared, for example, by organo lithium catalyzation in the presence of an organic hydrocarbon solvent.

A purpose of using S-SBR is for improved tire rolling resistance as a result of lower hysteresis when it is used in a tire tread composition.

The 3,4-polyisoprene rubber (3,4-PI) is considered beneficial for a purpose of enhancing the tire's traction when it is used in a tire tread composition. The 3,4-PI and use thereof is more fully described in U.S. Pat. No. 5,087,668 which is incorporated herein by reference.

The cis 1,4-polybutadiene rubber (BR) is considered to be beneficial for a purpose of enhancing the tire tread's wear, or treadwear. Such BR can be prepared, for example, by organic solution polymerization of 1,3-butadiene. The BR may be conveniently characterized, for example, by having at least a 90 percent cis 1,4-content.

The term “phr” as used herein, and according to conventional practice, refers to “parts by weight of a respective material per 100 parts by weight of rubber, or elastomer.”

In addition to the terpolymer of: ethylene, an α-olefin, and a non-conjugated diene and second rubber in the rubberized component of the tire, conventional fillers may be also present. The amount of such conventional fillers may range from 10 to 250 phr. Preferably, the filler is present in an amount ranging from 20 to 100 phr.

The commonly employed siliceous pigments which may be used in the rubber compound include conventional pyrogenic and precipitated siliceous pigments (silica), although precipitated silicas are preferred. The conventional siliceous pigments preferably employed in this invention are precipitated silicas such as, for example, those obtained by the acidification of a soluble silicate, e.g., sodium silicate.

Such conventional silicas might be characterized, for example, by having a BET surface area, as measured using nitrogen gas, preferably in the range of about 40 to about 600, and more usually in a range of about 50 to about 300 square meters per gram. The BET method of measuring surface area is described in the Journal of the American Chemical Society, Volume 60, Page 304 (1930).

The conventional silica may also be typically characterized by having a dibutylphthalate (DBP) absorption value in a range of about 100 to about 400, and more usually about 150 to about 300.

The conventional silica might be expected to have an average ultimate particle size, for example, in the range of 0.01 to 0.05 micron as determined by the electron microscope, although the silica particles may be even smaller, or possibly larger, in size.

Various commercially available silicas may be used, such as, only for example herein, and without limitation, silicas commercially available from PPG Industries under the Hi-Sil trademark with designations 210, 243, etc; silicas available from Rhone-Poulenc, with, for example, designations of Z1165MP and Z165GR and silicas available from Degussa AG with, for example, designations VN2 and VN3, etc.

Commonly employed carbon blacks can be used as a conventional filler. Representative examples of such carbon blacks include N110, N115, N121, N134, N220, N231, N234, N242, N293, N299, S315, N326, N330, M332, N339, N343, N347, N351, N358, N375, N539, N550, N582, N630, N642, N650, N660, N683, N754, N762, N765, N774, N787, N907, N908, N990 and N991. These carbon blacks have iodine absorptions ranging from 9 to 170 g/kg and DBP No. ranging from 34 to 150 cm³/100 g.

It may be preferred to have the rubber composition for use in the tire component to additionally contain a conventional sulfur containing organosilicon compound. Examples of suitable sulfur containing organosilicon compounds are of the formula:
Z-Alk-Sₙ-Alk-Z
in which Z is selected from the group consisting of 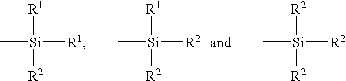
where R¹ is an alkyl group of 1 to 4 carbon atoms, cyclohexyl or phenyl; R² is alkoxy of 1 to 8 carbon atoms, or cycloalkoxy of 5 to 8 carbon atoms; Alk is a divalent hydrocarbon of 1 to 18 carbon atoms and n is an integer of 2 to 8.

Specific examples of sulfur containing organosilicon compounds which may be used in accordance with the present invention include: 3,3′-bis(trimethoxysilylpropyl)disulfide, 3,3′-bis(triethoxysilylpropyl)disulfide, 3,3′-bis(triethoxysilylpropyl)tetrasulfide, 3,3′-bis(triethoxysilylpropyl)octasulfide, 3,3′-bis(trimethoxysilylpropyl)tetrasulfide, 2,2′-bis(triethoxysilylethyl)tetrasulfide, 3,3′-bis(trimethoxysilylpropyl)trisulfide, 3,3′-bis(triethoxysilylpropyl)trisulfide, 3,3′-bis(tributoxysilylpropyl) disulfide, 3,3′-bis(trimethoxysilylpropyl)hexasulfide, 3,3′-bis(trimethoxysilylpropyl) octasulfide, 3,3′-bis(trioctoxysilylpropyl)tetrasulfide, 3,3′-bis(trihexoxysilylpropyl) disulfide, 3,3-bis(tri-2″-ethylhexoxysilylpropyl)trisulfide, 3,3′-bis(triisooctoxysilylpropyl)tetrasulfide, 3,3′-bis(tri-t-butoxysilylpropyl)disulfide, 2,2′-bis(methoxy diethoxy silyl ethyl)tetrasulfide, 2,2′-bis(tripropoxysilylethyl)pentasulfide, 3,3′-bis(tricyclonexoxysilylpropyl)tetrasulfide, 3,3′-bis(tricyclopentoxysilylpropyl)trisulfide, 2,2′-bis(tri-2″-methylcyclohexoxysilylethyl)tetrasulfide, bis(trimethoxysilylmethyl) tetrasulfide, 3-methoxy ethoxy propoxysilyl 3′-diethoxybutoxy-silylpropyltetrasulfide, 2,2′-bis(dimethyl methoxysilylethyl)disulfide, 2,2′-bis(dimethyl sec.butoxysilylethyl)trisulfide, 3,3′-bis(methyl butylethoxysilylpropyl)tetrasulfide, 3,3′-bis(di t-butylmethoxysilylpropyl)tetrasulfide, 2,2′-bis(phenyl methyl methoxysilylethyl)trisulfide, 3,3′-bis(diphenyl isopropoxysilylpropyl)tetrasulfide, 3,3′-bis(diphenyl cyclohexoxysilylpropyl) disulfide, 3,3′-bis(dimethyl ethylmercaptosilylpropyl)tetrasulfide, 2,2′-bis(methyl dimethoxysilylethyl)trisulfide, 2,2′-bis(methyl ethoxypropoxysilylethyl)tetrasulfide, 3,3′-bis(diethyl methoxysilylpropyl)tetrasulfide, 3,3′-bis(ethyl di-sec. butoxysilylpropyl) disulfide, 3,3′-bis(propyl diethoxysilylpropyl)disulfide, 3,3′-bis(butyl dimethoxysilylpropyl)trisulfide, 3,3′-bis(phenyl dimethoxysilylpropyl)tetrasulfide, 3-phenyl ethoxybutoxysilyl 3′-trimethoxysilylpropyl tetrasulfide, 4,4′-bis(trimethoxysilylbutyl)tetrasulfide, 6,6′-bis(triethoxysilylhexyl)tetrasulfide, 12,12′-bis(triisopropoxysilyl dodecyl)disulfide, 18,18′-bis(trimethoxysilyloctadecyl)tetrasulfide, 18,18′-bis(tripropoxysilyloctadecenyl)tetrasulfide, 4,4′-bis(trimethoxysilyl-buten-2-yl)tetrasulfide, 4,4′-bis(trimethoxysilylcyclohexylene)tetrasulfide, 5,5′-bis(dimethoxymethylsilylpentyl)trisulfide, 3,3 ′-bis(trimethoxysilyl-2-methylpropyl)tetrasulfide, 3,3′-bis(dimethoxyphenylsilyl-2-methylpropyl)disulfide.

The preferred sulfur containing organosilicon compounds are the 3,3′-bis(trimethoxy or triethoxy silylpropyl)sulfides. The most preferred compounds are 3,3′-bis(triethoxysilylpropyl)disulfide and 3,3′-bis(triethoxysilylpropyl)tetrasulfide. Therefore as to the above formula, preferably Z is 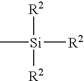
where R² is an alkoxy of 2 to 4 carbon atoms, with 2 carbon atoms being particularly preferred; alk is a divalent hydrocarbon of 2 to 4 carbon atoms with 3 carbon atoms being particularly preferred; and n is an integer of from 2 to 5 with 2 and 4 being particularly preferred.

The amount of the sulfur containing organosilicon compound of the above formula in a rubber composition will vary depending on the level of other additives that are used. Generally speaking, the amount of the compound of the above formula will range from 0.5 to 20 phr. Preferably, the amount will range from 1 to 10 phr.

It is readily understood by those having skill in the art that the rubber composition would be compounded by methods generally known in the rubber compounding art, such as mixing the various sulfur-vulcanizable constituent rubbers with various commonly used additive materials such as, for example, sulfur donors, curing aids, such as activators and retarders and processing additives, such as oils, resins including tackifying resins and plasticizers, fillers, pigments, fatty acid, zinc oxide, waxes, antioxidants and antiozonants and peptizing agents. As known to those skilled in the art, depending on the intended use of the sulfur vulcanizable and sulfur vulcanized material (rubbers), the additives mentioned above are selected and commonly used in conventional amounts. Representative examples of sulfur donors include elemental sulfur (free sulfur), an amine disulfide, polymeric polysulfide and sulfur olefin adducts. Preferably, the sulfur vulcanizing agent is elemental sulfur. The sulfur vulcanizing agent may be used in an amount ranging from 0.5 to 8 phr, with a range of from 1.5 to 6 phr being preferred. Typical amounts of tackifier resins, if used, comprise about 0.5 to about 10 phr, usually about 1 to about 5 phr. Typical amounts of processing aids comprise about 1 to about 50 phr. Such processing aids can include, for example, aromatic, naphthenic, and/or paraffinic processing oils. Typical amounts of antioxidants comprise about 1 to about 5 phr. Representative antioxidants may be, for example, diphenyl-p-phenylenediamine and others, such as, for example, those disclosed in The Vanderbilt Rubber Handbook (1978), Pages 344 through 346. Typical amounts of antiozonants comprise about 1 to 5 phr. Typical amounts of fatty acids, if used, which can include stearic acid comprise about 0.5 to about 3 phr. Typical amounts of zinc oxide comprise about 2 to about 5 phr. Typical amounts of waxes comprise about 1 to about 5 phr. Often microcrystalline waxes are used. Typical amounts of peptizers comprise about 0.1 to about 1 phr. Typical peptizers may be, for example, pentachlorothiophenol and dibenzamidodiphenyl disulfide.

Accelerators are used to control the time and/or temperature required for vulcanization and to improve the properties of the vulcanizate. In one embodiment, a single accelerator system may be used, i.e., primary accelerator. The primary accelerator(s) may be used in total amounts ranging from about 0.5 to about 4, preferably about 0.8 to about 1.5, phr. In another embodiment, combinations of a primary and a secondary accelerator might be used with the secondary accelerator being used in smaller amounts, such as from about 0.05 to about 3 phr, in order to activate and to improve the properties of the vulcanizate. Combinations of these accelerators might be expected to produce a synergistic effect on the final properties and are somewhat better than those produced by use of either accelerator alone. In addition, delayed action accelerators may be used which are not affected by normal processing temperatures but produce a satisfactory cure at ordinary vulcanization temperatures. Vulcanization retarders might also be used. Suitable types of accelerators that may be used in the present invention are amines, disulfides, guanidines, thioureas, thiazoles, thiurams, sulfenamides, dithiocarbamates and xanthates. Preferably, the primary accelerator is a sulfenamide. If a second accelerator is used, the secondary accelerator is preferably a guanidine, dithiocarbamate or thiuram compound.

The mixing of the rubber composition can be accomplished by methods known to those having skill in the rubber mixing art. For example the ingredients are typically mixed in at least two stages, namely at least one non-productive stage followed by a productive mix stage. The final curatives including sulfur vulcanizing agents are typically mixed in the final stage which is conventionally called the “productive” mix stage in which the mixing typically occurs at a temperature, or ultimate temperature, lower than the mix temperature(s) than the preceding non-productive mix stage(s). The rubber and compound is mixed in one or more non-productive mix stages. The terms “non-productive” and “productive” mix stages are well known to those having skill in the rubber mixing art. If the rubber composition contains a sulfur-containing organosilicon compound, one may subject the rubber composition to a thermomechanical mixing step. The thermomechanical mixing step generally comprises a mechanical working in a mixer or extruder for a period of time suitable in order to produce a rubber temperature between 140° C. and 190° C. The appropriate duration of the thermomechanical working varies as a function of the operating conditions and the volume and nature of the components. For example, the thermomechanical working may be from 1 to 20 minutes.

The rubber composition may be incorporated in a variety of rubber components of the tire. For example, the rubber component may be a tread (including tread cap and tread base), sidewall, apex, chafer, sidewall insert, wirecoat, innerliner, and ply coat. Preferably, the compound is a sidewall insert or a tread.

In one embodiment, the rubber composition is incorporated in the ground contacting tread of a tire. The rubber composition shows abrasion resistance and tear resistance that is particularly advantageous when the composition is used in a tread.

The pneumatic tire of the present invention may be a passenger tire, motorcycle tire, aircraft tire, agricultural, earthmover, off-the-road, truck tire and the like. The term “truck tire” includes light truck, medium truck and heavy truck. Preferably, the tire is a passenger or truck tire. The tire may also be a radial or bias, with a radial being preferred.

Vulcanization of the pneumatic tire of the present invention is generally carried out at conventional temperatures ranging from about 100° C. to 200° C. Preferably, the vulcanization is conducted at temperatures ranging from about 110° C. to 180° C. Any of the usual vulcanization processes may be used such as heating in a press or mold, heating with superheated steam or hot air.

Upon vulcanization of the sulfur vulcanized composition, the rubber composition of this invention can be used for various purposes. For example, the sulfur vulcanized rubber composition may be in the form of a tire, belt or hose. In case of a tire, it can be used for various tire components. Such tires can be built, shaped, molded and cured by various methods which are known and will be readily apparent to those having skill in such art. As can be appreciated, the tire may be a passenger tire, aircraft tire, truck tire and the like. Preferably, the tire is a passenger tire. The tire may also be a radial or bias, with a radial tire being preferred.

In one embodiment, the tire is an off-the-road type tire, for example as disclosed in any of U.S. Pat. No. 4,823,855; U.S. Pat. No. 5,085,259; and U.S. Pat. No. 6,530,405; all of which are fully incorporated herein by reference in their entireties. In this embodiment, the tire includes a tread having a plurality of ground contacting tread lugs, wherein at least part of the tread has a net-to-gross ratio of less than 50 percent. In another embodiment, at least part of the tread has a net-to-gross ratio of less than 40 percent. “Net-to-gross ratio” is a term understood in the art, as defined in U.S. Pat. No. 6,530,405. As defined therein, net-to-gross ratio is the total of ground contacting tread elements between the lateral edges around the entire circumference of the tread divided by the gross area of the entire tread between the lateral edges. Thus, tires with lower net-to-gross ratio will have wider tread grooves between adjacent tread lugs.

In one embodiment, the tire includes a puncture resistant sidewall as disclosed in co-pending U.S. patent application Ser. No. 11/212,524, fully incorporated herein by reference in its entirety. As disclosed in Ser No. 11/212,524, the rubber sidewall is comprised of, based upon parts by weight per 100 parts by weight rubber (phr):

(A) an outer, visible annular configured sidewall rubber layer comprising at least one diene based elastomer;

(B) an inner (non-visible) annular configured sidewall rubber layer integral with and underlying said outer sidewall layer which comprises, based upon parts by weight per 100 parts by weight rubber (phr):
(1) conjugated diene-based elastomers comprised of:
   (a) about 40 to about 80, preferably from about 45 to about 70, phr of cis 1,4-polyisoprene rubber, preferably natural rubber,
   (b) about 20 to about 60, preferably from about 30 to about 55, phr of cis 1,4-polybutadiene rubber,
   (c) optionally from zero to about 30, alternately from about 5 to about 20, phr of styrene/butadiene copolymer rubber;
(2) about 55 to about 80 phr of reinforcing filler as:
   (a) about 5 to about 40 phr of rubber reinforcing carbon black having an Iodine value (ASTM D1510) in a range of from about 30 to about 90 g/kg and a dibutylphthalate (DBP) value (ASTM D2414) value in a range of from about 70 to about 130 cc/100 g, and
   (b) about 10 to about 70 phr of synthetic amorphous precipitated silica, (wherein the weight ratio of said precipitated silica to said rubber reinforcing carbon black is preferably in a range of from about 0.8/1 to about 1.5/1);
(3) a coupling agent for said precipitated silica having a moiety reactive with hydroxyl groups (e.g. silanol groups) contained on said precipitated silica and another moiety interactive with said conjugated diene-based elastomers, and
(4) a dispersion therein of short fibers in a range of about 1 to about 12 phr thereof, wherein said short fibers are preferably comprised of at least one of aramid and nylon filaments, preferably at least one aramid filament.
wherein said short fibers are substantially aligned in a parallel relationship to each other and substantially parallel to said annular configuration of said inner sidewall rubber layer.

The short fibers may have an average length, for example, of less than 0.5 millimeters (mm).

In one embodiment, the inner layer of the oriented fiber reinforced rubber is underlying and integral with (in a sense of being co-cured with in a suitable tire mold) the outer, visible rubber sidewall layer to enhance the tire sidewall's penetration resistance (e.g. puncture resistance by an impacting foreign object).

In another embodiment, the tire is comprised of a carcass which contains a rubber carcass ply comprised of a rubber encapsulated cord reinforcement of a plurality of cords wherein said cords are positioned in a radially disposed (the cords extend in a radial direction outward from the bead portion of the tire to its circumferential tread), spaced apart substantially parallel relationship to each other, wherein the rubber carcass ply is integral with and underlies the inner rubber sidewall layer and wherein the short fibers of the inner rubber sidewall layer are substantially aligned in a perpendicular direction to the cords of said underlying carcass ply.

In another embodiment, the short fibers in the rubber layer are positioned within the tire sidewall which overlies a tire carcass ply in a manner that the oriented short fibers are as a right angle (90 degree angle) to the direction of the carcass ply cord in a manner that further enhances the tire sidewall's penetration resistance (e.g. puncture resistance by an impacting foreign object).

In another embodiment, along with the tread comprising the terpolymer of ethylene, an α-olefin, and a non-conjugated diene, the tire comprises a composite fabric ply located in the shoulder portions of the tire, as disclosed in copending Ser. No. 11/147,948 filed Jun. 8, 2005, fully incorporated herein by reference. As disclosed in Ser. No. 11/147, 948, in this embodiment the pneumatic tire comprises a tread portion, a belt package radially beneath the tread portion, a pair of sidewall portions, a pair of shoulder portions with each shoulder portion extending between the tread portion and each sidewall portion, a pair of bead portions with a bead core therein, and a carcass comprising at least one carcass ply extending between the bead portions and turnup up around the bead core in each bead portion to form two tumup portions and a main portion therebetween. The tire has at least one ply of a composite fabric. The composite fabric has three layers with the middle layer comprising a plurality of straight warp yams wherein the three layers are bound together with binder yams. At a minimum, the composite fabric ply is located in the tire shoulders.

The outer layers of the composite fabric ply may be woven in any conventional weave pattern or may be formed of only weft yams. Optionally, the straight warp yams of the middle layer have a cord diameter of 0.25 to 4 mm. The yams forming the three layers and the binder yams of the composite fabric are selected from the group consisting of polyester, nylon, aramid, PET, PEN, and blends thereof. In weaving the composite fabric, different yam types may be combined to form the different layers.

The composite fabric ply may be located between the carcass ply and the belt package. Alternatively, the composite fabric may be located radially outward of the belt package. If desired to achieve particular tire characteristics, multiple layers of the composite fabric may form the entire belt package.

The composite fabric ply may extend continuously from one shoulder portion to the opposing shoulder portion or may be formed as separate reinforcing strips. The radially inner ends of the composite fabric, in the form of either the axially continuous ply or the spaced reinforcing strips, may be located radially outward of the maximum section width of the tire or adjacent the turnup portion of the carcass. In one embodiment, the radially inner end of the composite fabric ply is spaced from the maximum section width of the tire by a distance Y in the range of 5 -30% of the section height of the tire. Alternatively, when formed as an axially continuous ply, the composite fabric ply has an axial width CW in the range of 60 -110% the belt package width BW.

When formed as spaced strips, the axially inner end of each composite fabric ply strip is located radially outward or radially inward of the belt package. Also, the composite fabric ply strips overlap the belt package by an axial width of 10 to 25% of the belt package width BW.

Additionally, when formed as strips in the sidewalls of the tire, the composite fabric ply strips may be identified as having a length LF of 20 to 45% of the length LC of the carcass ply, wherein the length LF is actual length of the composite fabric ply strip and the length LC is the length of the main portion of the carcass ply.

In another disclosed embodiment of Ser. No. 11/147948, the pneumatic tire of claim may have both a composite fabric ply that extends continuously from one shoulder portion to the opposing shoulder portion and composite fabric ply strips in each tire sidewall.

In another embodiment, along with the tread comprising the terpolymer of ethylene, an α-olefin, and a non-conjugated diene, the tire comprises at least one belt layer comprising a steel cord, as disclosed in copending Ser. No. 11/315,507 filed Dec. 22, 2005, fully incorporated herein by reference. As disclosed in Ser. No. 11/315,507, the tire has a tread, a radial carcass, and a belt structure, wherein the belt structure has at least one working belt layer and includes at least one outermost protective belt layer. At least one of the belt layers is formed of a steel cord wherein the steel cord has a construction of N×(7×2) wherein N=1 to 7. Within the circumference of the cross-sectional area of the cord, not more than 60% of the cord area is comprised of the steel filaments. Preferably, not more than 50% of the cord area is comprised of the steel filaments.

In another aspect of the invention, the steel cords in the belt layer have an elongation at break of at least 3.0%.

In another aspect of the invention, the belt structure of the tire has at least four belt layers, and at least the radially outermost belt layer is comprised of the N×(7×2) steel cords. Alternatively, the two radially outermost belt layers may be formed of the N×(7×2) steel cords.

The invention is further illustrated by the following non-limiting examples.

### EXAMPLE 1

In this Example, a terpolymer of: ethylene, an α-olefin, and a non-conjugated diene was evaluated in a synthetic polyisoprene composition containing carbon black.

Rubber composition containing the materials set out in Table 1 were prepared using two separate stages of addition (mixing); namely one non-productive mix stage and one productive mix stage. The non-productive stage was mixed for four minutes to a rubber temperature of 160° C. The productive stage was mixed for two minutes, and the drop temperature for the productive mix stage was 115° C.

The rubber compositions are identified as Sample 1 through Sample 3. Samples 1 and 2 are considered as controls due to the absence of terpolymer of ethylene, an α-olefin, and a non-conjugated diene.

The Samples were cured at about 150° C. for about 36 minutes.

Table 2 illustrates the physical properties of the cured Samples 1 through 3.

TABLE 1

| Sample No. | | |
|---|---|---|
| 1 | 2 | 3 |

First Non-productive Mix Stage

| | | | |
|---|---|---|---|
| Synthetic cis 1,4-polyisoprene rubber¹ | 100 | 100 | 100 |
| Carbon black² | 50 | 50 | 50 |
| Processing oil³ | 5 | 0 | 0 |
| Polyolefin⁴ | 0 | 5 | 0 |
| Terpolymer⁵ | 0 | 0 | 5 |
| Zinc oxide | 3 | 3 | 3 |
| Fatty acid⁶ | 2 | 2 | 2 |
| Antidegradant⁷ | 2 | 2 | 2 |

Productive Mix Stage

| | | | |
|---|---|---|---|
| Insoluble sulfur | 1.4 | 1.4 | 1.4 |
| Accelerator, sulfenamide⁸ | 1 | 1 | 1 |

¹NAT2200 from the Goodyear Tire & Rubber Company
²ASTM N299
³Flexon 641 from ExxonMobil
⁴Engage 8445, 90 percent ethylene, 10 percent octene, M.P. 103° C., Mooney 8
⁵Nordel IP NDR 4920, 90 percent ethylene, 5 percent propylene, 5 percent ENB, melting point 91° C., Mooney ML (1 + 4) at 125° C. = 10.
⁶Blend comprised of stearic, palmitic and oleic acids
⁷Quinoline type
⁸Tertiary butyl sulfenamide

TABLE 2

| | Sample No. | | |
|---|---|---|---|
| | 1 | 2 | 3 |
| Processing oil | 5 | 0 | 0 |
| Polyolefin | 0 | 5 | 0 |
| Terpolymer | 0 | 0 | 5 |

Rheometer, 150° C.

| | | | |
|---|---|---|---|
| Maximum torque, dNm | 18.5 | 19.3 | 19.6 |
| Minimum torque, dNm | 2.6 | 2.9 | 3.0 |
| Delta torque, dNm | 15.9 | 16.4 | 16.6 |
| T₉₀, minutes | 9.7 | 10.9 | 11.3 |

Stress-strain (ASTM D412) at 23° C.

| | | | |
|---|---|---|---|
| Tensile strength, MPa | 24.3 | 24.9 | 24.7 |
| Elongation at break (%) | 487 | 487 | 480 |
| 300% Modulus, MPa | 12.6 | 13.5 | 13.6 |

Rebound (Zwick)

| | | | |
|---|---|---|---|
| 23° C. | 50 | 50 | 50 |
| 100° C. | 66 | 65 | 65 |

Shore A Hardness

| | | | |
|---|---|---|---|
| 23° C. | 65 | 69 | 70 |
| 100° C. | 59 | 62 | 62 |

Tear Strength, 95° C.

| | | | |
|---|---|---|---|
| N | 107 | 77 | 76 |

DIN Abrasion

| | | | |
|---|---|---|---|
| Relative cc volume loss | 118 | 121 | 113 |

RPA at 100° C., 1 Hz

| | | | |
|---|---|---|---|
| G′ (10% strain), kPa | 1097 | 1267 | 1291 |
| Tan delta (10% strain) | 0.134 | 0.138 | 0.138 |

It can be seen from Table 2 that a substantial improvement in abrasion is observed for Sample 3 comprising the terpolymer of: ethylene, an α-olefin, and a non-conjugated diene, as compared with Samples 1 and 2.

### EXAMPLE 2

In this Example, a terpolymer of ethylene, an α-olefin, and a non-conjugated diene was evaluated in an emulsion polymerized styrene butadiene composition containing carbon black.

Rubber composition containing the materials set out in Table 2 were prepared using two separate stages of addition (mixing); namely one non-productive mix stage and one productive mix stage. The non-productive stage was mixed for four minutes to a rubber temperature of 160° C. The productive stage was mixed for two minutes, and the drop temperature for the productive mix stage was 115° C.

The rubber compositions are identified as Sample 4 through Sample 6. Samples 4 and 6 are considered as controls due to the absence of terpolymer of ethylene, an α-olefin, and a non-conjugated diene.

The Samples were cured at about 150° C. for about 36 minutes.

Table 4 illustrates the physical properties of the cured Samples 4 through 6.

TABLE 3

| Sample No. | | |
|---|---|---|
| 4 | 5 | 6 |

First Non-productive Mix Stage

| | | | |
|---|---|---|---|
| Emulsion SBR rubber¹ | 100 | 100 | 100 |
| Carbon black² | 50 | 50 | 50 |
| Processing oil³ | 5 | 0 | 0 |
| Polyolefin⁴ | 0 | 5 | 0 |
| Terpolymer⁵ | 0 | 0 | 5 |
| Zinc oxide | 3 | 3 | 3 |
| Fatty acid⁶ | 2 | 2 | 2 |
| Antidegradant⁷ | 2 | 2 | 2 |

Productive Mix Stage

| | | | |
|---|---|---|---|
| Insoluble sulfur | 1 | 1 | 1 |
| Accelerator, sulfenamide⁸ | 1 | 1 | 1 |
| Accelerator, guanidine⁹ | 1 | 1 | 1 |

¹PLF1502 from the Goodyear Tire & Rubber Company
²ASTM N299
³Flexon 641 from ExxonMobil
⁴Engage 8445, 90 percent ethylene, 10 percent octene, M.P. 103° C., Mooney 8
⁵Nordel IP NDR 4820, 85 percent ethylene, 10 percent propylene, 5 percent ENB, melting point 80° C., Mooney ML (1 + 4) at 125° C. = 15, crystallinity 28 weight percent, crystallization temperature = 79° C.
⁶Blend comprised of stearic, palmitic and oleic acids
⁷Quinoline type
⁸Tertiary butyl sulfenamide
⁹Diphenyl guanidine

TABLE 4

| | Sample No. | | |
|---|---|---|---|
| | 4 | 5 | 6 |
| Processing Oil | 5 | 0 | 0 |
| Polyolefin | 0 | 5 | 0 |
| Terpolymer | 0 | 0 | 5 |

Rheometer, 150° C.

| | | | |
|---|---|---|---|
| Maximum torque, dNm | 15.7 | 16.1 | 16.8 |
| Minimum torque, dNm | 2.4 | 2.7 | 2.8 |
| Delta torque, dNm | 13.3 | 13.4 | 14.0 |
| T₉₀, minutes | 16.9 | 15.6 | 17.4 |

Stress-strain (ASTM D412) at 23° C.

| | | | |
|---|---|---|---|
| Tensile strength, MPa | 23.6 | 25.8 | 25.1 |
| Elongation at break (%) | 513 | 504 | 507 |
| 300% Modulus, MPa | 11.3 | 13.3 | 12.7 |

Rebound (Zwick)

| | | | |
|---|---|---|---|
| 23° C. | 45 | 44 | 44 |
| 100° C. | 55 | 55 | 54 |

Shore A Hardness

| | | | |
|---|---|---|---|
| 23° C. | 68 | 72 | 72 |
| 100° C. | 57 | 60 | 60 |

Tear Strength, 95° C.

| | | | |
|---|---|---|---|
| N | 128 | 114 | 147 |

DIN Abrasion

| | | | |
|---|---|---|---|
| Relative cc volume loss | 87 | 80 | 77 |

RPA at 100° C., 1 Hz

| | | | |
|---|---|---|---|
| G′ (10% strain), KPa | 1102 | 1150 | 1187 |
| Tan delta (10% strain) | 0.162 | 0.171 | 0.161 |

As seen in Table 3, Sample 6 containing the terpolymer of: ethylene, an α-olefin, and a non-conjugated diene showed significantly improved tear strength and abrasion resistance as compared with Samples 4 and 5.

### EXAMPLE 3

In this Example, a terpolymer of ethylene, an α-olefin, and a non-conjugated diene was evaluated in an synthetic cis 1,4-polyisoprene composition containing carbon black and silica.

Rubber composition containing the materials set out in Table 5 were prepared using two separate stages of addition (mixing); namely one non-productive mix stage and one productive mix stage. The non-productive stage was mixed for four minutes to a rubber temperature of 160° C. The productive stage was mixed for two minutes, and the drop temperature for the productive mix stage was 115° C.

The rubber compositions are identified as Sample 7 and Sample 8. Sample 7 is considered as a control due to the absence of a terpolymer of ethylene, an α-olefin, and a non-conjugated diene.

The Samples were cured at about 150° C. for about 36 minutes.

Table 6 illustrates the physical properties of the cured Samples 7 and 8.

TABLE 5

Sample No.

| | |
|---|---|
| 7 | 8 |

First Non-productive Mix Stage

| | | |
|---|---|---|
| Synthetic cis 1,4-polyisoprene rubber¹ | 100 | 100 |
| Carbon black² | 20 | 20 |
| Silica⁴ | 15 | 15 |
| Processing oil³ | 5 | 0 |
| Terpolymer⁵ | 0 | 0 |
| Zinc oxide | 3 | 3 |
| Fatty acid⁶ | 2 | 2 |
| Antidegradant⁷ | 2 | 2 |
| Silane coupling agent¹⁰ | 3 | 3 |

Non-Productive Mixing Step 2

| | | |
|---|---|---|
| Silica | 15 | 15 |
| Silane Coupling Agent | 2 | 2 |

Productive Mix Stage

| | | |
|---|---|---|
| Insoluble sulfur | 1.4 | 1.4 |
| Accelerator, sulfenamide⁸ | 1.8 | 1.8 |
| Accelerator, guanidine⁹ | 0.5 | 0.5 |

¹NAT2200 from the Goodyear Tire & Rubber Company
²ASTM N299
³Flexon 641 from ExxonMobil
⁴Synthetic, amorphous precipitated silica as HiSil ® 243 from PPG
⁵Nordel IP NDR 4920, 90 percent ethylene, 5 percent propylene, 5 percent ENB, melting point 91° C., Mooney ML (1 + 4) at 125° C. = 10
⁶Blend comprised of stearic, palmitic and oleic acids
⁷Quinoline type
⁸Tertiary butyl sulfenamide
⁹Diphenyl guanidine
¹⁰X50S from DeGussa, 50 percent active, bis(3-triethoxysilyspropyl)tetrasulfide

TABLE 6

Sample No.

| | 7 | 8 |
|---|---|---|
| Processing Oil | 5 | 0 |
| Terpolymer | 0 | 5 |

Rheometer, 150° C.

| | | |
|---|---|---|
| Maximum torque, dNm | 20.2 | 21.6 |
| Minimum torque, dNm | 2.2 | 2.3 |
| Delta torque, dNm | 18 | 19.3 |
| T₉₀, minutes | 13.2 | 14.3 |

Stress-strain (ASTM D412) at 23° C.

| | | |
|---|---|---|
| Tensile strength, MPa | 21.2 | 23.9 |
| Elongation at break (%) | 470 | 489 |
| 300% Modulus, MPa | 12.3 | 13.4 |

Rebound (Zwick)

| | | |
|---|---|---|
| 23° C. | 53 | 53 |
| 100° C. | 68 | 67 |

Shore A Hardness

| | | |
|---|---|---|
| 23° C. | 66 | 71 |
| 100° C. | 65 | 68 |

Tear Strength, 95° C.

| | | |
|---|---|---|
| N | 52 | 35 |

DIN Abrasion

| | | |
|---|---|---|
| Relative cc volume loss | 126 | 117 |

RPA at 100° C., 1 Hz

| | | |
|---|---|---|
| G′ (10% strain), kPa | 1397 | 1556 |
| Tan delta (10% strain) | 0.120 | 0.125 |

It can be seen from Table 6 that a substantial improvement in abrasion is observed for Sample 8 comprising the terpolymer of: ethylene, an α-olefin, and a non-conjugated diene, as compared with Sample 7.

### EXAMPLE 4

In this Example, a terpolymer of ethylene, an α-olefin, and a non-conjugated diene was evaluated in a rubber composition containing carbon black, silica and a Chinese gum rosin.

Rubber composition containing the materials set out in Table 7 were prepared using two separate stages of addition (mixing); namely one non-productive mix stage and one productive mix stage. The non-productive stage was mixed for four minutes to a rubber temperature of 160° C. The productive stage was mixed for two minutes, and the drop temperature for the productive mix stage was 115° C.

The rubber compositions are identified as Samples 9, 10 and 11. Sample 9 is considered to be a control due to the absence of the terpolymer.

The Samples were cured at about 150° C. for about 36 minutes. Table 8 illustrates the physical properties of the cured Samples 9, 10 and 11.

TABLE 7

| | Sample No. | | |
|---|---|---|---|
| | 9 | 10 | 11 |
| Natural Rubber | 75 | 60 | 50 |
| Polybutadiene¹ | 25 | 30 | 30 |
| Terpolymer² | 0 | 10 | 20 |
| Carbon Black | 47 | 47 | 47 |
| Silica | 10 | 10 | 10 |
| Silane Coupling Agent | 2 | 2 | 2 |
| Resin³ | 4 | 4 | 4 |
| Accelerator⁴ | 1.15 | 1.27 | 1.27 |
| Sulfur | 0.9 | 0.9 | 0.9 |

¹Budene 1207 from The Goodyear Tire & Rubber Co.
²Nordel IP NDR 4820, 85 percent ethylene, 10 percent propylene, 5 percent ENB, melting point 80° C., Mooney ML (1 + 4) at 125° C. = 15, crystallinity 28 weight percent, crystallization temperature = 79° C.
³water white gum rosin, from Hercules BV
⁴Sulfenamide type

TABLE 8

| | Sample No. | | |
|---|---|---|---|
| | 9 | 10 | 11 |
| Terpolymer, phr | 0 | 10 | 20 |

MDR @ 160° C.

| | | | |
|---|---|---|---|
| T90, min | 6.99 | 7.08 | 6.79 |
| TS1, min | 1.82 | 1.7 | 1.64 |
| Min Torque | 3.78 | 3.55 | 3.6 |
| Max Torque | 16.52 | 15.52 | 15.59 |
| Delta Torque | 12.74 | 11.97 | 11.99 |
| Final Torque | 15.43 | 14.8 | 14.81 |
| T25, min | 2.8 | 2.67 | 2.53 |
| T50, min | 3.73 | 3.61 | 3.41 |
| T80, min | 5.58 | 5.54 | 5.27 |

Original ATS @ 23° C.

| | | | |
|---|---|---|---|
| 100% Modulus, MPa | 1.67 | 2.08 | 2.85 |
| 200% Modulus, MPa | 4.02 | 4.4 | 5.64 |
| 300% Modulus, MPa | 8.54 | 8.49 | 10.0 |
| Tensile Strength, MPa | 21.1 | 20.6 | 20.0 |
| Elongation, % | 563 | 593 | 554 |
| Energy, J | 198 | 214 | 207 |
| Hardness, RT | 68.4 | 73.2 | 79.8 |
| Hardness, 100° C. | 59.5 | 59 | 60.5 |
| Rebound, RT | 40.5 | 38 | 37 |
| Rebound, 100° C. | 51 | 47.5 | 46.1 |

Aged (7 Days/70° C.) ATS @ 23° C.

| | | | |
|---|---|---|---|
| 100% Modulus, MPa | 2.24 | 2.8 | 3.73 |
| 200% Modulus, MPa | 5.83 | 6.38 | 7.73 |
| 300% Modulus, MPa | 11.7 | 11.8 | 13.2 |
| Tensile Strength, MPa | 21.8 | 20.7 | 20.3 |
| Elongation, % | 508 | 507 | 484 |
| Energy, J | 192 | 187 | 188 |
| Hardness, RT | 71.9 | 77.3 | 83.8 |
| Hardness, 100° C. | 63.7 | 64 | 65.8 |
| Rebound, RT | 44.4 | 41.1 | 39.5 |
| Rebound, 100° C. | 36.5 | 51.9 | 49.6 |

RPA

| | | | |
|---|---|---|---|
| Cured G′ @1%/40 C./11 Hz, MPa | 5.39 | 7.54 | 10.05 |
| Cured G″ @1%/40 C./11 Hz, MPa | 0.80 | 1.16 | 1.52 |
| Cured Tan Delta @1%/40 C./11 Hz | 0.13 | 0.15 | 0.15 |
| Cured G′ @1%/100 C./11 Hz, MPa | 3.27 | 3.27 | 3.28 |
| Cured G′ @10% 100 C./11 Hz, MPa | 1.40 | 1.43 | 1.48 |
| Cured G′ @14%/100 C./11 Hz, MPa | 1.27 | 1.30 | 1.34 |
| Cured Tan Delta @10%/100 C./11 Hz | 0.23 | 0.24 | 0.26 |
| Cured G′ @50% 100 C./1 Hz, MPa | 0.81 | 0.80 | 0.78 |
| Cured Tan Delta @50%/100 C./1 Hz | 0.16 | 0.18 | 0.22 |

DIN Abrasion

| | | | |
|---|---|---|---|
| Relative Volume Loss, cm³ | 104 | 91 | 81 |

Tear Strength

| | | | |
|---|---|---|---|
| Original, test @ 95° C., N | 255 | 339 | 285 |
| Aged 4 days at 70° C., test @ 95° C., N | 175 | 319 | 231 |

Goodrich Flex

| | | | |
|---|---|---|---|
| Temp Change from MTS Goodrich | 39.6 | 48.3 | 58.6 |
| Flex, ° C. | | | |
| Penetration Energy 0-5 mm, J | 0.12 | 0.17 | 0.24 |
| Penetration Energy 0-20 mm, J | 3.96 | 5.02 | 6.44 |

From Table 8, it can be seen that 100% modulus, 200% modulus, and hardness at 23° C. for both original and aged compounds containing the terpolymer are significantly increased with increasing terpolymner. However, original and aged hardness at 100° C. did not change significantly. The same behavior is also observed for the storage modulus, G′ at both 40° C. and 100° C.

Also from Table 8, it can be seen that the tensile strength and elongation at break for both original and aged compounds with the terpolymer did not significantly change. Rebound was slightly reduced with increasing amount of the terpolymer. However, the aged hot rebound is much improved for the sample with the terpolymer than for the sample without the terpolymer (Samples 10 and 11 versus Sample 9).

The RPA results shown in Table 8 and FIG. 1 are consistent with the tensile modulus results. As was the case for the tensile modulus versus temperature for the compounds reinforced by the terpolymer, the storage modulus, G′, was significantly increased by increasing the terpolymer loading at temperatures below 100° C. At higher temperatures nearing 100° C. and above, the modulus approaches that of the compound without the terpolymer. These results are considered to be significant in that an increase in stiffness with increasing terpolymer concentration is observed in a range of temperature up to about 100° C., while above that temperature no effect of the terpolymer on stiffness is observed.

Further from Table 8, it can be seen that penetration energy was significantly increased by increasing the terpolymer. Original and aged hot tear strength also significantly improved, especially in the aged tear and the compound with 10 phr terpolymer. It considered to be significant that they are an indication of good cutting/chipping/chunking resistance and an extended durability for life compared to one without the terpolymer.

In addition, DIN abrasion resistance was improved by adding the terpolymer, however, heat build-up also increased as indicated by the increased tan delta.

It is clearly shown that a small amount (10 phr) of the terpolymer in the tread compound has significantly improved compound properties including stiffness and tear strength, which are of benefit to cutting/chipping /chunking resistance, without loss of wear resistance. The DIN result suggests that it may improve wear resistance.

As will be appreciated by one skilled in the art, the tread compound containing the terpolymer will be particularly useful in off-the-road tires having large tread lugs and a low net-to-gross ratio. In such tires, running of the tread over sharp rocks and uneven terrain can result in cutting, chipping, and/or chunking of the tread. “Chipping” has been defined in the Michelin Factbook (www.michelingc.com/na_eng/pages/Glossary.html) as “flaking or tearing away small bits of tread rubber,” and “chunking” as “tearing or breaking away pieces of tread rubber.” As taught by Niedermier et al., Rubber World, August 2005, cutting results from tread striking sharp objects causing repetitive high pressures to the tread surface and leading to penetration or cutting. Niedermier further teaches that chipping can follow cutting during running and braking on such sharp objects causing tearing of the rubber. Finally, Niedermier notes that chunking results from localized high pressures in hot tread on rough roads, leading to compound fracture because of reduced compound elongation. The fractures can result in tearing of tread chunks from the tread. It will be appreciated that off the road tires with low net-to-gross ratio have wide tread grooves between large tread lugs. When running on rough terrain, rocks and other sharp objects can enter in the grooves between lugs and impart high pressures on tread lugs leading to tearing and chunking. The improved tear strength of the inventive compound as illustrated in Table 8 indicates that an off the road tire with a low net-to-gross ratio and the inventive compound will benefit from reduced chunking of the tread.

While certain representative embodiments and details have been shown for the purpose of illustrating the invention, it will be apparent to those skilled in this art that various changes and modifications may be made therein without departing from the spirit or scope of the invention.

What is claimed is:

1. A pneumatic tire having a tread comprising a plurality of ground contacting tread lugs comprising:
at least one rubber selected from polybutadiene rubber, styrene-butadiene rubber, synthetic polyisoprene rubber, and natural rubber; and
from 1 to 30 parts by weight, per 100 parts by weight of rubber, of a terpolymer of: ethylene, an α-olefin, and a non-conjugated diene; the terpolymer having an ethylene content of greater than 80 percent by weight and a Mooney viscosity (ML 1+4 at 125° C.) of from 5 to 25 as measured by ASTM D-1646;
wherein at least part of the tread has a net-to-gross ratio of less than 50 percent.

2. The pneumatic tire of claim 1, wherein at least part of the tread has a net-to-gross ratio of less than 40 percent.

3. The pneumatic tire of claim 1 wherein the component comprises from 5 to 15 parts by weight, per 100 parts by weight of rubber, of the terpolymer of: ethylene, an α-olefin, and a non-conjugated diene.

4. The pneumatic tire of claim 1 wherein the α-olefin is selected from the group consisting of propylene, butene, pentene, and octene.

5. The pneumatic tire of claim 1 wherein the non-conjugated diene is selected from the group consisting of 1,4-hexadiene, dicyclopentadiene and ethylidenenorbomene.

6. The pneumatic tire of claim 1 wherein the α-olefin is propylene and the non-conjugated diene is ethylidenenorbomene.

7. The pneumatic tire of claim 1 wherein the terpolymer has an ethylene content of greater than 85 percent by weight.

8. The pneumatic tire of claim 1 wherein said the terpolymer has a Mooney viscosity (ML 1+4 at 125° C.) of from 10 to 20 as measured by ASTM D-1646.

9. The pneumatic tire of claim 1 wherein the component further comprises 10 to 250 phr of a filler selected from carbon black and silica.

10. The pneumatic tire of claim 9 wherein said filler comprises silica.

11. The pneumatic tire of claim 9 wherein said filler comprises carbon black.

12. The pneumatic tire of claim 1 wherein the component further comprises from 0.5 to 20 phr of a sulfur containing organosilicon compound of the formula:
Z-Alk-Sₙ-Alk-Z
in which Z is selected from the group consisting of 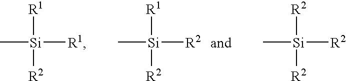
where R¹ is an alkyl group of 1 to 4 carbon atoms, cyclohexyl or phenyl; R² is alkoxy of 1 to 8 carbon atoms, or cycloalkoxy of 5 to 8 carbon atoms; Alk is a divalent hydrocarbon of 1 to 18 carbon atoms and n is an integer of 2 to 8.

13. The pneumatic tire of claim 1 wherein said component is thermomechanically mixed at a rubber temperature in a range of from 140° C. to 190° C. for a total mixing time of from 1 to 20 minutes.

14. The pneumatic tire of claim 1, wherein the terpolymer of ethylene, an α-olefin, and a non-conjugated diene has a crystalline content greater than 25 percent by weight as measured by differential scanning calorimetry (DSC) at a rate of 10° C./minute.
